(19) United States
(12) Patent Application Publication
(10) Pub. No.: US 2006/0163207 A1
(43) Pub. Date: Jul. 27, 2006

(54) Substrate treating apparatus and substrate treating method using the same

(76) Inventors: Young-sig Lee, Chungcheongnam-do (KR); Ki-hyun Kim, Chungcheongnam-do (KR); Hong-je Cho, Chungcheongnam-do (KR); Kwan-Tack Lim, Gyeonggi-do (KR); Jae-kyeong Lee, Gyeonggi-do (KR)

Correspondence Address: DLA PIPER RUDNICK GRAY CARY US, LLP, 2000 UNIVERSITY AVENUE, E. PALO ALTO, CA, 94303-2248, US

(21) Appl. No.: 11/184,357

(22) Filed: Jul. 18, 2005

(30) Foreign Application Priority Data
Jul. 19, 2004 (KR) 10-2004-0055951
Jan. 27, 2005 (KR) 10-2005-0007483
Feb. 18, 2005 (KR) 10-2005-0013487

(51) Int. Cl. B05D 7/00; C03C 15/00; B05C 5/00; C23F 1/00; B05D 1/02

(52) U.S. Cl. 216/92; 427/421.1; 118/300; 156/345.17; 156/345.21

(57) ABSTRACT

Disclosed is a substrate treating apparatus including a treatment solution dispenser supplying a treatment solution on a substrate, a transporting unit transporting the substrate, and a controller controlling the transporting unit so that the substrate is transported in an inclined position. The substrate is inclined sideways through a rotation with respect to an axis extending parallel to a transportation direction of the substrate. The rotation may be made in both directions in an alternating manner. The apparatus is useful for treating the substrate uniformly regardless of substrate size.

### CROSS-REFERENCE TO RELATED APPLICATIONS

This application claims the benefit of Korean Patent Application Nos. 2004-0055951, 2005-0007483 and 2005-0013487, filed on Jul. 19, 2004, Jan. 27, 2005, and Feb. 18, 2005 in the Korean Intellectual Property Office, the contents of which are incorporated herein by reference.

### BACKGROUND OF THE INVENTION

1. Field of the Invention

The present invention relates to a substrate treating apparatus and a substrate treating method using the same.

2. Description of the Related Art

A liquid crystal panel (LCD) comprises a liquid crystal panel having a thin film transistor (TFT) substrate on which TFTs are formed, a color filter substrate on which a color filter layer is formed, and a liquid crystal layer disposed between the two substrates. The liquid crystal panel does not emit light by itself, so a backlight unit is often disposed behind the TFT substrate for providing light to the liquid crystal panel. The amount of light transmitted by the backlight unit depends on the alignment of the liquid crystal molecules.

Further, the LCD includes a driving circuit driving each pixel of the liquid crystal panel and gate and data drivers receiving driving signals from the driving circuit and supplying voltage to a data line and a gate line.

Fabricating the color filter substrate and the TFT substrate entails treating the substrates by providing a treatment solution. Specifically, fabricating the substrate entails a developing process forming a photosensitive layer pattern from a light-exposed photosensitive layer, an etching process forming a metal layer pattern or an electrode pattern by using the photosensitive layer pattern formed through the developing process, and a washing process washing the substrate that was subjected to the developing process or the etching process. These processes employ a developing solution, an etching solution, and DI (de-ionized) water, respectively.

Treating the substrate typically involves transporting the substrate while a treatment solution is sprayed on the substrate. During the transport process, the substrate is in an inclined position to facilitate the removal of the treatment solution. While moving the substrate in an inclined position facilitates the removal of the treatment solution, it causes the problem of the treatment solution flowing from the higher end to the lower end of the substrate and accumulating near the lower part of the inclined substrate This accumulation results in the treatment solution being applied with different thicknesses between the higher end and the lower end of the substrate. The uneven thicknesses, in turn, cause the effective spraying pressure applied to the substrate to be higher on the upper part of the inclined substrate than on the lower part.

The difference of the spraying pressure causes a nonuniform treatment of the surface of the substrate. As the size of the substrate becomes larger, the nonuniformity gets worse. This nonuniform treatment problem does not occur where a dipping method is employed in which the substrate is immersed in the treatment solution,. However, it is well known that the dipping method is difficult to implement when the substrate is lager than a certain size.

Recently, with the substrates becoming larger, the uniformity of a wiring width and an etching profile has become an issue. Treating the substrate uniformly is an essential factor for achieving the wiring uniformity. However, uniform treatment of a substrate is difficult to achieve if the treatment condition differs for different parts of the substrate. A method of uniformly treating a substrate regardless of its size is desired.

### SUMMARY OF THE INVENTION

Accordingly, it is an aspect of the present invention to provide a substrate treating apparatus treating the substrate uniformly.

It is another aspect of the present invention to provide a substrate treating method treating the substrate uniformly.

The foregoing and/or other aspects of the present invention are also achieved by providing a substrate treating apparatus including a treatment solution dispenser supplying a treatment solution on a substrate, a transporting unit transporting the substrate; and a controller controlling the transporting unit so that the substrate is transported in an inclined position. The inclined position is achieved through a rotation with respect to an axis extending parallel to a transportation direction of the substrate. The substrate may be inclined in both directions in an alternating manner.

It is another aspect of the present invention to provide a substrate treating apparatus including a transporting unit transporting a substrate in an inclined position, and a treatment solution dispenser placed above the transporting unit and spraying a treatment solution more intensely on a lower part of the inclined substrate than on an upper part of the inclined substrate.

According to the embodiment of the present invention, the treatment solution dispenser comprises a plurality of nozzles, and the nozzle spraying the treatment solution on the lower part of the inclined substrate is disposed more closely to the substrate than the nozzle spraying the treatment solution on the upper part of the inclined substrate.

According to the embodiment of the present invention, the treatment solution dispenser comprises a treatment solution pipe disposed in the transverse direction with respect to the transportation direction of the substrate and a plurality of nozzles connected with the treatment solution pipe.

According to the embodiment of the present invention, the treatment solution pipe is capable of adjusting its inclination angle.

According to the embodiment of the present invention, the treatment solution pipe is disposed parallel with the substrate, and the nozzle spraying the treatment solution on the lower part of the inclined substrate is longer than the nozzle spraying the treatment solution on the upper part of the inclined substrate.

According to the embodiment of the present invention, the treatment solution pipe is disposed parallel with the substrate, and the nozzle is longer as the nozzle gets close to the lower part of the inclined substrate.

According to the embodiment of the present invention, the treatment solution pipe is closer to the lower part of the inclined substrate than to the upper part of the inclined substrate.

According to the embodiment of the present invention, the treatment solution dispenser comprises a nozzle having a first nozzle spraying the treatment solution on the upper part of the inclined substrate and a second nozzle spraying the treatment solution on the lower part of the inclined substrate, and a treatment solution pipe having a first treatment solution pipe connected with the first nozzle and a second treatment solution pipe connected with the second nozzle.

According to the embodiment of the present invention, the treatment solution dispenser comprises a plurality of treatment solution pipes disposed parallel with the transportation direction of the substrate and a plurality of nozzles connected with the treatment solution pipe.

According to the embodiment of the present invention, the distance between the upper part of the inclined substrate and the treatment solution pipe is longer than that between the lower part of the inclined substrate and the treatment solution pipe.

According to the embodiment of the present invention, the nozzle spraying the treatment solution on the lower part of the inclined substrate is closer to the substrate than the nozzle spraying the treatment solution on the upper part of the inclined substrate.

It is another aspect of the present invention to provide a substrate treating method comprising preparing a substrate and a treatment solution, and transporting the substrate in an inclined position, wherein the inclined position is achieved by rotating the substrate with respect to an axis extending parallel to a transportation direction of the substrate. The substrate is rotated in both directions in an alternating manner while receiving the treatment solution.

According to the embodiment of the present invention, the transporting comprises transporting the substrate forward and backward at least one time.

According to the embodiment of the present invention, an inclination angle of the substrate is 3° to 7°.

According to the embodiment of the present invention, the treatment solution is one of a developing solution, an etching solution and a washing solution.

It is another aspect of the present invention to provide a substrate treating method including supplying a treatment solution to a substrate in a first treating unit while transporting the substrate that is inclined at a first inclination angle through a rotation with respect to an axis extending parallel to the transportation direction of the substrate. The method also includes supplying the treatment solution to the substrate in a second treating unit while transporting the substrate that is inclined at a second inclination angle smaller than the first inclination angle, and supplying the treatment solution to the substrate in a third treating unit while transporting the substrate being inclined at a third inclination angle that is a reverse to the first inclination angle.

According to the embodiment of the present invention, the substrate is transported horizontally in the second treating unit.

According to the embodiment of the present invention, the first inclination angle is equal to the third inclination angle.

It is another aspect of the present invention to provide a substrate treating method comprising transporting a substrate that is inclined sidewayws through a rotation with respect to an axis extending parallel to a transportation direction of the substrate and supplying a treatment solution such that a spraying pressure of the treatment solution applied on a lower part of the inclined substrate is higher than that applied on an upper part of the inclined substrate.

### BRIEF DESCRIPTION OF THE DRAWINGS

The above and/or other aspects and advantages of the present invention will become apparent and more readily appreciated from the following description of the exemplary embodiments, taken in conjunction with the accompanying drawings of which:

FIG. 1 is a sectional view of a substrate treating apparatus according to a first embodiment of the present invention;

FIG. 2 is a perspective view illustrating an operation of the substrate treating apparatus according to the first embodiment of the present invention;

FIG. 3 is a flow chart of a substrate treating method using the substrate treating apparatus according to the first embodiment of the present invention;

FIG. 4 is a perspective view illustrating another operation of the substrate treating apparatus according to the first embodiment of the present invention;

FIG. 5 is a flow chart of another substrate treating method using the substrate treating apparatus according to the first embodiment of the present invention;

FIG. 6 is a perspective view of an essential part of a substrate treating apparatus according to a second embodiment of the present invention;

FIG. 7 is a side view of an essential part of the substrate treating apparatus according to the second embodiment of the present invention;

FIG. 8 is a side view of an essential part of a substrate treating apparatus according to a third embodiment of the present invention;

FIG. 9 is a side view of an essential part of a substrate treating apparatus according to a fourth embodiment of the present invention;

FIG. 10 is a perspective view of an essential part of a substrate treating apparatus according to a fifth embodiment of the present invention; and

FIG. 11 is a side view of an essential part of the substrate treating apparatus according to the fifth embodiment of the present invention.

### DETAILED DESCRIPTION OF THE PREFERRED EMBODIMENT

Reference will now be made in detail to exemplary embodiments of the present invention, examples of which are illustrated in the accompanying drawings, wherein like reference numerals refer to like elements throughout. The embodiments are described below in order to explain the present invention by referring to the figures.

As used herein, a substrate moving “forward and backward” indicates that the substsrate is movable in both directions along the transportion direction. A substrate being “inclined” or “inclined sideways” means the substrate is rotated with respect to an axis that extends parallel to the transporting direction. An inclination angle that is the “reverse” of another angle describes the relationship between an angle φ and an angle −φ measured with respect to the same reference line.

### First Embodiment

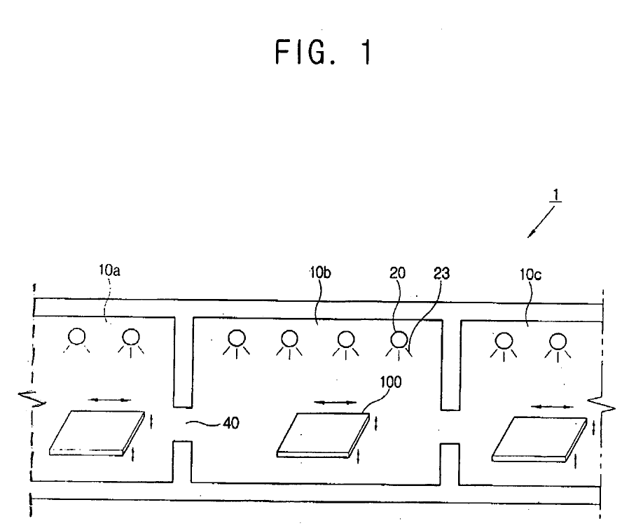

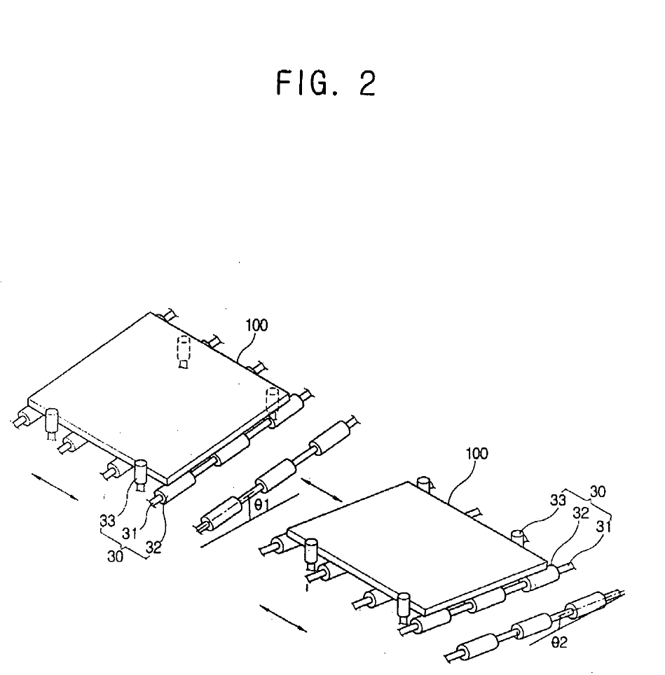

A substrate treating apparatus according to a first embodiment of the present invention will be described with reference to FIGS. 1 and 2.

A substrate treating apparatus 1 according to the first embodiment of the present invention comprises a plurality of treating units 10a, 10b and 10c having similar configurations.

Each of the treating units 10a, 10b, 10c has a tub and is connected to an adjacent treating unit(s) 10a, 10b, 10c. Between the adjacent treating units 10a, 10b, and 10c is provided a passage 40 through which a substrate 100 is transported between the treating units.

A treatment solution dispenser 20 is disposed in an upper part of each treating unit 10a, 10b, 10c to supply the substrate 100 with a treatment solution 23. The treatment solution dispenser 20 supplies the treatment solution 23 to the substrate 100 by spraying. A plurality of treatment solution dispensers 20 are disposed along a transporting route of the substrate 100 so that the treatment solution 23 is supplied to the overall substrate 100 uniformly. Although not shown in figures, the treatment solution dispenser 20 may be connected to a treatment solution storage tank.

The treatment solution 23 may be a developing solution, an etching solution, or a washing solution depending on the use of the treating apparatus 1.

If the treatment solution 23 is a developing solution, an organic alkaline based solution that dose not contain a metal ingredient is used, and the alkaline ingredients are removed through a washing process.

If the treatment solution 23 is an etching solution, the exact compositions of the etching solution varies according to the composition of the etching target. For example, the etching solution for Al or Mo includes phosphoric acid, nitric acid, and acetic acid. The etching solution for Ta includes hydrofluoric acid and nitric acid. The etching solution for Cr includes ammonium nitrate caesium and nitric acid. The etching solution for ITO (indium tin oxide) includes hydrochloric acid, nitric acid and ferric chloride.

If the treatment solution 23 is a washing solution, the treatment solution 23 is typically DI (de-ionized) water. For quick washing, the treating unit 10a, 10b and 10c may comprise not only the treatment solution dispenser 20 but also the well known “aqua knife” of which a nozzle is formed in a direction perpendicular to a transportation direction of the substrate 100.

The substrate 100, seated on a transporting unit 30, moves forward and backward in the treating unit 10a, 10b and 10c, or is transported between the treating units 10a, 10b and 10c. The substrate 100 is disposed under the treatment solution dispenser 20 to be sprayed with the treatment solution 23, with the part that is to be treated by the treatment solution 23 exposed. If the treatment process is for developing, a light-exposed photosensitive layer is exposed. If the treatment process is for etching, the parts to be etched, such as a metal layer, a transparent electrode layer, and/or an insulating layer are exposed and the parts that are not to be etched are covered with a photosensitive layer. If the treatment process is for washing, the developing solution or the etching solution, the photosensitive layer that is peeled off by the developing process and the metal layer that is peeled off by the etching process are exposed.

The transporting unit 30 includes a conveyor belt type mechanism. The transporting unit 30 transports the substrate 100 between the treating units 10a, 10b, and 10c, and moves the substrate 100 forward and backward within one treating unit 10a, 10b or 10c. The transporting unit 30 comprises a plurality of rollers 31 disposed parallel to one another and capable of rotating forward or backward, supporters 32 combined with the roller 31 and directly contacting a rear surface of the substrate 100, and side rollers 33 that are rotated by the movement of the substrate 100. The side rollers 33 keep the substrate 100 on the transport unit 30 by supporting the side surfaces of the substrate 100. The side rollers 33 are provided along both sides of the substrate 100. The transporting unit 30 is made of material that is not reactive with or damaged by the treatment solution 23. The supporter 32 is preferably made of a material like plastic that does not to affect the substrate 100. The transporting unit 30 includes a controller (not shown) directing the roller 31 whether to rotate and which direction to rotate.

The controller controls the transporting unit 30 so that the substrate 100 is transported while being inclined sideways in alternative directions. In FIG. 2, a first inclination angle θ1 has an opposite direction to a second inclination angle θ2 with respect to the horizontal axis signifying 0° in a reference coordinate 35, and each inclination angle may be 3° to 7°. If the inclination angle is smaller than 3°, the treatment solution 23 is removed too slowly. On the other hand, if the inclination angle is larger than 7°, the treatment solution 23 remains on the substrate 100 for too short a time. In some cases, the inclination angles θ1 and θ2 may be equal.

Although not shown in the figures, the transporting unit 30 may include an inclination control member that controls the sideways inclination direction and the inclination angle of the substrate 100. The inclination control member may include a piston device.

The treating apparatus 1 can be modified in various ways. For example, more than three treating units 10a, 10b and 10c may be provided for a treating apparatus 1.

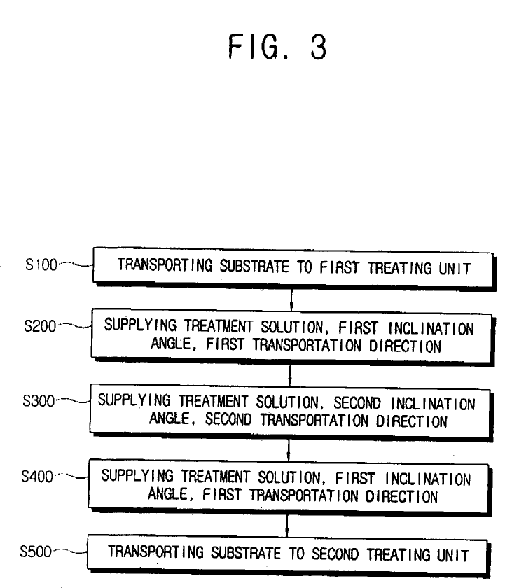

Now, a substrate treating method using the treating apparatus according to the first embodiment will be described with reference to FIG. 3. For example, a process for forming a gate wiring on the substrate 100 is as follows.

A gate metal layer is deposited on an insulating substrate and sprayed with a photosensitive solution. Then, a solvent within the photosensitive solution is removed through a soft-bake process thereby forming a photosensitive layer. Subsequently, the photosensitive layer from which the solvent is removed is exposed to light by a mask having a certain pattern. Afterwards, the developing is performed in the following process.

First, the substrate 100, seated on the transporting unit 30, is moved to the first treating unit 10a at step 101. The treatment solution 23 sprayed from the treatment solution dispenser 21, namely, the developing solution starts to be supplied to the substrate 100 when the substrate 100 is carried into the first treating unit 10a. Upon receiving the developing solution, the substrate 100 develops the photosensitive layer in step 200. If a negative type of photosensitive solution is applied, the area of the photosensitive layer that is not exposed to light reacts with the treatment solution 23 and is dissolved. If a positive type of photosensitive solution is applied, the area of the photosensitive layer that is exposed to light reacts with the treatment solution 23 and is dissolved. In step 200, the substrate 100 is transported from the first treating unit 10a toward a second treating unit 10b in a first transportation direction. The transporting unit 30 transports the substrate 100 in a sideways-inclined position, forming a first inclination angle. Since the substrate 100 is inclined, the treatment solution 23 remains on the lower part of the inclined substrate 100 longer than on the upper part of the substrate 100.

After transporting the substrate 100 in the first transportation direction for a predetermined time, the transporting unit 30 transports the substrate 100 in a second transportation direction that is a reverse direction to the first transportation direction (step 300). While transporting the substrate 100 in the second transportation direction, the transporting unit 30 inclines the substrate 100 to form a second inclination angle. Where the first inclination angle is φ, the second inclination angle may be −φ in the reference coordinate 35 (see FIG. 2). Due to the second inclination angle being in the opposite direction of the first inclination angle, the part of the substrate 100 that was the lower end when the substrate was tilted to form the first inclination angle becomes the upper end when the substrate is tilted to form the second inclination angle. Likewise, the part of the substrate 100 that was the upper end when the substrate 100 was tilted to form the first inclination angle becomes the lower end when the substrate 100 is tilted in the opposite direction, i.e. to form the second inclination angle. Therefore, the area covered with a large amount of the treatment solution 23 in step 200 contacts a small amount of the treatment solution 23 in step 300. Conversely, the area covered with a small amount of the treatment solution 23 in step 200 contacts a large amount of the treatment solution 23 in step 300.

After finishing the transportation in the second transportation direction in step 300, the transporting unit 30 transports the substrate 100 back in the first transportation direction (step 400). At this time, the inclination direction of the substrate 100 is switched back to the first inclination direction. Even though the inclination direction is switched, the substrate 100 does not fall off the transporting unit 30 because of the side roller 33 disposed at opposite sides of the substrate 100.

After the substrate 100 reaches the passage 40 by moving in the first transportation direction in step 400, the transporting unit 30 carries out the substrate 100 to the adjacent treating unit 10b in step 500. After the substrate 100 is transported to the second treating unit 10b, the foregoing process is repeated, and the substrate 100 is carried out to a third treating unit 10c.

Meanwhile, another substrate 100 is transported to the first treating unit 10a, and the above process is repeated. Thus, multiple substrates can be processed simultaneously with one treating apparatus 1, whereas the substrates are in different stages of the process at a given time.

Through theses processes, the developing of the photosensitive layer is completed when the substrate 100 exits from the third treating unit 10c. Since the substrate 100 is inclined sideways in an alternating manner during the developing process, the problem of the developing solution contacting the substrate 100 unevenly is at least partly resolved.

After the developing process, the substrate 100 undergoes the washing process, the etching process, and another washing process. These processes are similar to the above-described developing process.

Since the treatment solution 23 contacts the overall substrate 100 uniformly, the lack of uniformity in the gate wiring is reduced.

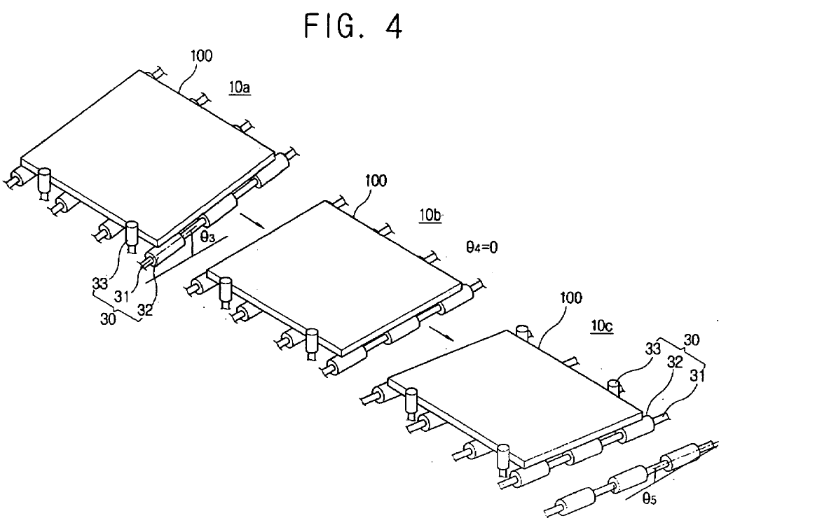

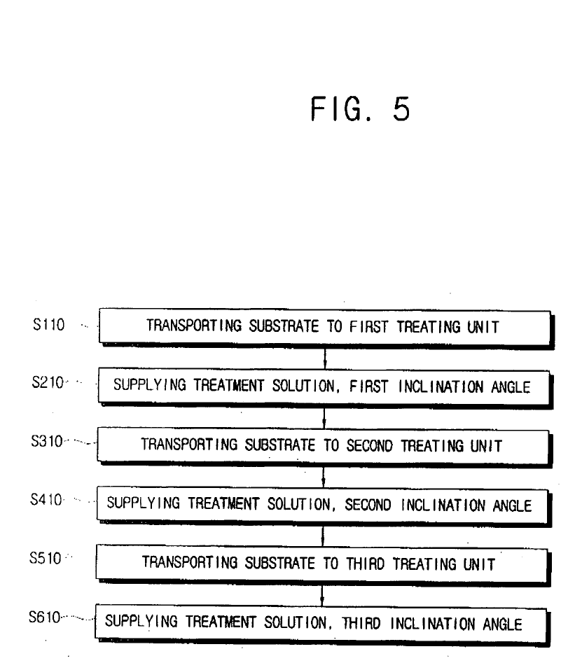

Now, another substrate treating method using the substrate treating apparatus according to the first embodiment of the present invention will be described with reference to FIGS. 4 and 5.

The substrate 100 has a single inclination angle in one treating unit 10a, 10b, or 10c. For example, a developing process is as follows.

The substrate 100, seated on the transporting unit 30, is transported into the first treating unit 10a at operation 110. The treatment solution 23 sprayed from the treatment solution dispenser 20, namely the developing solution, starts to be supplied on the substrate 100 when the substrate 100 is carried into the first treating unit 10a and develops the photosensitive layer in step 210. The substrate 100 is transported from the first treating unit 10a to a second treating unit 10b, and this direction is referred to as a first transportation direction. Also, the substrate 100 is transported while being inclined sideways by as much as the first inclination angle (θ3). The lower part of the substrate 100 contacts the treatment solution 23 longer than the upper part of the substrate 100.

The transporting unit 30 can move the substrate 100 forward in the first transportation direction, or backward in the second transportation direction reverse to the first transportation direction.

After the step 210, the substrate 100 is transported to the second treating unit 10b in step 310. The substrate 100 is transported horizontally and undergoes the developing treatment in step 410. In other words, the second inclination angle θ4 in the second treating unit 10b becomes 0°. Accordingly, the treatment solution 23 contacts the substrate 100 uniformly. As in the first treating unit 10a, the transporting unit 30 may move the substrate 100 forward or backward.

Next, the substrate 100 is moved onto the third treating unit 10c in step 510.

While being transported into the third treating unit 10c, the substrate 100 is inclined sideways by as much as the third inclination angle θ3 by the transporting unit 30 in step 610. The third inclination angle θ5 has the same value as the first inclination angle θ3, but has a reverse direction to the first inclination angle θ3. Namely, the part of the substrate 100 that was the lower end in the first treating unit 10a becomes the upper end in the third treating unit 10c. Conversely, the part of the substrate 100 that was the upper end in the first treating unit 10a becomes the lower end in the third treating unit 10c. Therefore, the area that was covered with a large amount of the treatment solution 23 in step 210 contacts a small amount of the treatment solution 23 in step 610 and, the area that was covered with a small amount of the treatment solution 23 in step 210 contacts a large amount of the treatment solution 23 in step 610. As in the above cases, the transporting unit 30 may move the substrate 100 forward and backward.

Meanwhile, another substrate 100 is carried into the first treating unit 10a and the above processes are repeated.

### Second Embodiment

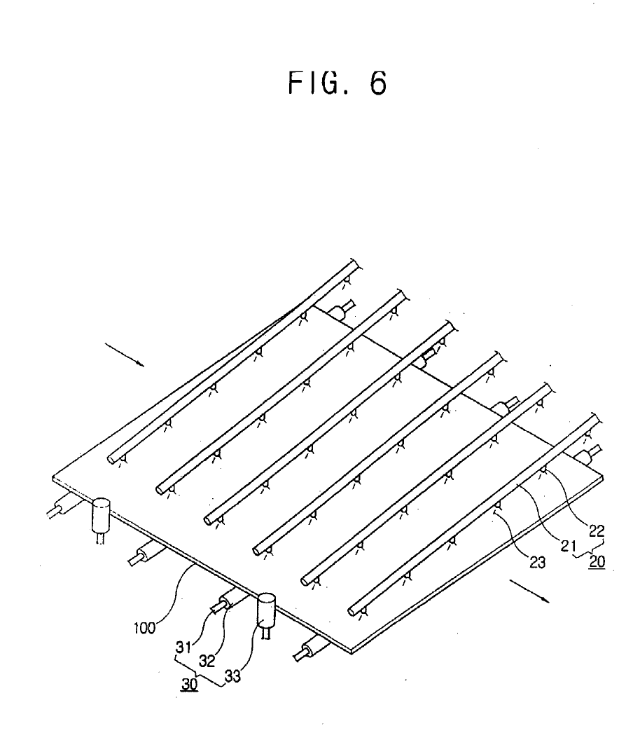

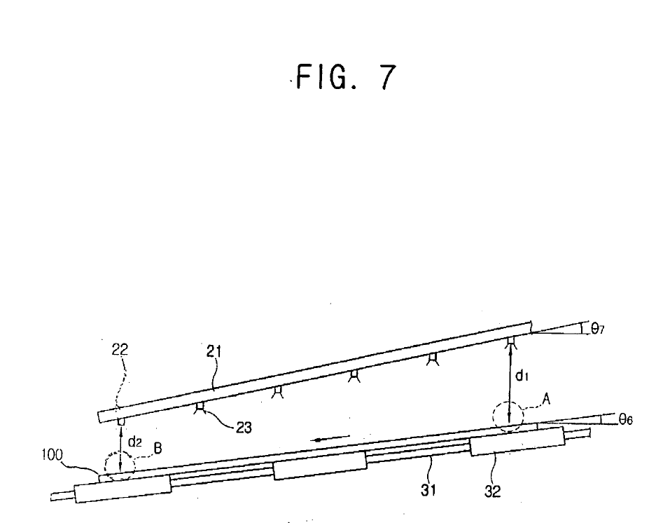

Below here, a substrate treating apparatus according to a second embodiment of the present invention will be described with reference to FIGS. 6 and 7.

A treatment solution dispenser 20 is extended in a direction that is perpendicular to the transportation direction of a substrate 100, and includes a plurality of treatment solution pipes 21 parallel with one another and a plurality of nozzles 22 connected to each treatment solution pipe 21. A treatment solution 23 is supplied to the treatment solution pipe 21 through a treatment solution tank (not shown) and a treatment solution pump (not shown). The treatment solution 23, which is supplied to the treatment solution pipe 21, is sprayed on substrate 100 through the nozzle 22. FIG. 6 shows a case where the substrate has a rectangular shape with two long sides and two short sides. As shown in FIG. 6, if the long sides of the substrate 100 are parallel to the transportation direction of the substrate 100, the treatment solution pipe 21 is disposed parallel to one of the short sides of the substrate 100. The spacial interval between the treatment solution pipes 21 may be constant. The spacial interval between the nozzles 22 also may be constant.

Now, a spraying pressure of the treatment solution 23 applied on the substrate 100 will be described.

As shown in FIG. 7, the substrate 100, seated on the transporting unit 30, is inclined at a predetermined angle θ6 so that the treatment solution 23 can be removed quickly from the substrate 100. In the embodiment, the inclination angle θ6 of the substrate 100 may be 3° to 7°.

The treatment solution pipe 21 disposed above the substrate 100 is also inclined at an inclination angle θ7, the inclination angle θ7 of the treatment solution pipe 21 being larger than that θ6 of the substrate 100. The The inclination angle θ7 of the treatment solution ipe 21 may be adjustable. Due to an inclination angle difference, the distance d1 between the upper part A of the inclined substrate 100 and the nozzle 22 is greater than the distance d2 between a lower part B of the inclined substrate 100 and the nozzle 22. Accordingly, in the case that each nozzle 22 is operated with the same spraying pressure, the spraying pressure that is applied to the lower part B of the inclined substrate 100 will be more intense than on the upper part A of the inclined substrate 100.

A substrate treating method using the substrate treating apparatus 1 according to the second embodiment of the present invention is as follows.

When the substrate 100 is transported by the transporting unit 30 to under the treatment solution dispenser 20, the treatment solution 23 is sprayed uniformly on the overall substrate 100 through the nozzles 22. The treatment solution 23 sprayed on the upper part A of the inclined surface of the substrate 100 treats the upper part A, and then flows down to the lower part B of the inclined surface of the substrate 100. The treatment solution 23 sprayed on an area between the upper part A and the lower part B of the inclined substrate 100 flows down to the lower part B after treating the substrate 100. Thus, the treatment solution 23 accumulates on the lower part B, and the lower part B is dipped in the treatment solution 23. Consequently, the upper part A is treated by spraying the treatment solution 23 but the lower part B is treated by being dipped in the accumulated pool of treatment solution 23. The substrate 100 is treated without uniformity.

In the second embodiment, the lower part B of the inclined substrate 100 can be treated with spraying by reducing the distance d2 between the lower part B of the inclined substrate 100 and the nozzle 22 and therefore increasing the spraying pressure of the treatment solution 23 applied to the substrate 100. Further, due to the intense spraying pressure of the treatment solution 23, the treatment solution 23 that is accumulated on the lower part B is quickly removed from the substrate 100. With this configuration, the treatment solution 23 is sprayed on the overall substrate 100, thereby treating the substrate 100 uniformly.

After the above treatment is completed, the substrate 100 is transported to the next process. If the treatment is a developing process, the next process may be a washing process or an etching process. If the treatment is the etching process, the next process may be the washing process. If the treatment is the washing process, the next process may be a drying process.

### Third Embodiment

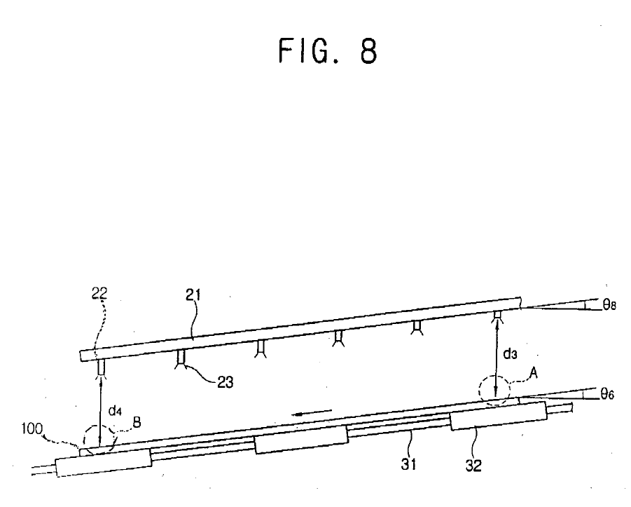

A substrate treating apparatus according to a third embodiment of the present invention will be described with reference to FIG. 8.

In this embodiment, an inclination angle θ6 of a substrate 100 is the same as the inclination angle θ8 of a treatment solution pipe 21. The nozzle 22 near the low end B is made longer than the nozzle 22 near the upper end A. Thus, the outlet of the longer nozzle 22 is closer to a lower part B of the inclined substrate 100 than if the nozzle 22 were the same length as the nozzle 22 for the upper end A. With this configuration, a distance d3 between an upper part A of the substrate 100 and the nozzle 22 is longer than that d4 between the lower part B and the nozzle 22. If each nozzle 22 sprays the treatment solution 23 with the same spraying pressure, the spraying pressure is applied to the lower part B of the inclined substrate 100 more intensely than to the upper part A, thereby treating the substrate 100 uniformly.

### Fourth Embodiment

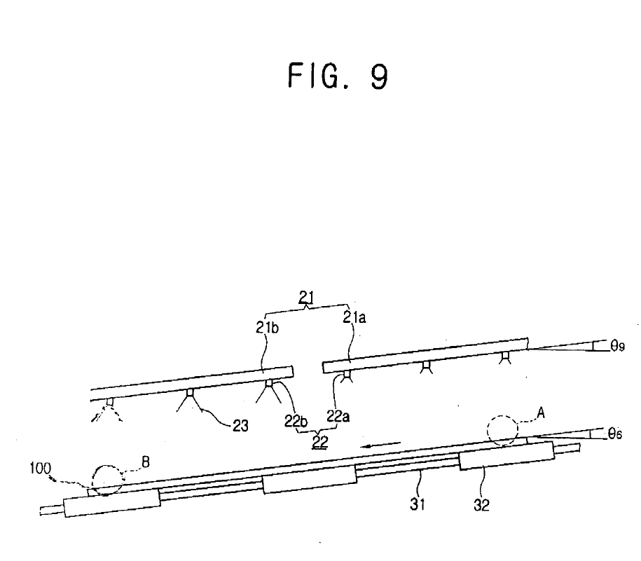

A substrate treating apparatus according to a fourth embodiment of the present invention will be described with reference to FIG. 9.

An inclination angle θ6 of a substrate 100 is the same as the inclination angle θ8 of a treatment solution pipe 21. The treatment solution pipe 21 includes a first treatment solution pipe 21a supplying an upper part A of the inclined substrate 100 with a treatment solution 23 and a second treatment solution pipe 21b supplying a lower part B of the inclined substrate 100 with the treatment solution 23. The nozzle 22 includes a first nozzle 22a connected with the first treatment solution pipe 21a and a second nozzle 22b connected with the second treatment solution pipe 21b. Although not shown in the figures, each of the first treatment solution pipe 21a and second treatment solution pipe 22b are connected to a respective treatment solution pump supplying the treatment solution 23 at different pressures. In the fourth embodiment, the spraying pressure of the treatment solution 23 sprayed from the second nozzle 22b connected with the second treatment solution pipe 21b is higher than that sprayed from the first nozzle 22a connected with the first treatment solution pipe 21a. Consequently, the spraying pressure of the treatment solution 23 is applied to the lower part B of the inclined substrate 100 is higher than on the upper part A, thereby treating the substrate 100 uniformly.

### Fifth Embodiment

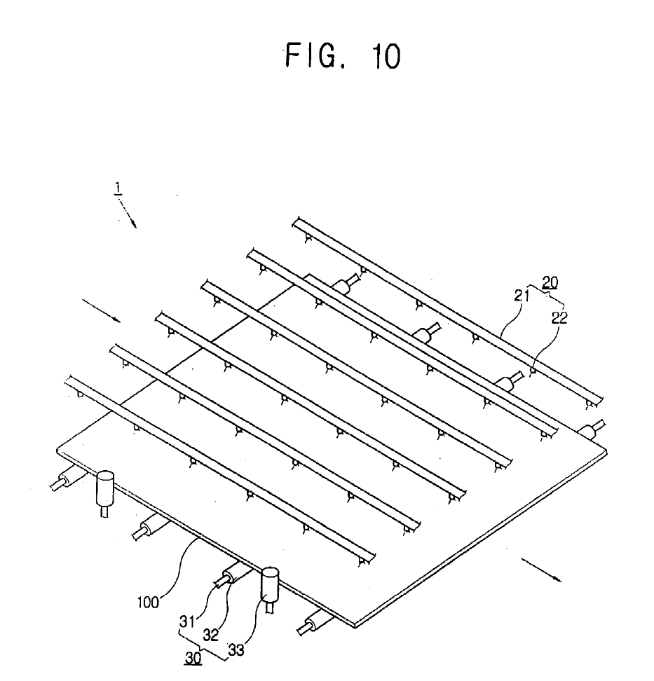

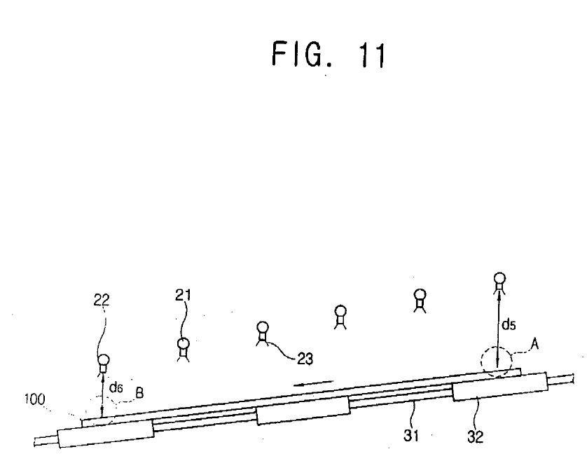

A substrate treating apparatus according to a fifth embodiment of the present invention will be described with reference to FIGS. 10 and 11.

A treatment solution pipe 21 is disposed parallel to the transportation direction of a substrate 100. The treatment solution pipes 21 may be spaced apart by a constant interval. Likewise, the nozzles 22 may be spaced apart by a constant interval.

The distance between the treatment solution pipe 21 and the substrate 100 decreases as the treatment solution pipe 21 becomes closer to a lower part B of the inclined substrate 100. Thus, a distance d5 between an upper part A of the inclined substrate 100 and the nozzle 22 is larger than the distance d6 between the lower part B and the nozzle 22. Due to the varying separation distance, the treatment solution 23 is sprayed on the lower part B of the inclined surface of the substrate 100 more intensely than on the upper part A, thereby treating the substrate 100 uniformly.

The above embodiments can be modified in various ways. For example, the inclination angles of the substrate and the treatment solution pipe may be different, and the length of the nozzle may be changeable. Further, the sideways inclination angle of the substrate in either direction may be adjusted along with the spraying pressure of the treatment solution to achieve the desired uniformity.

Although the above embodiments illustrate the substrate for an LCD, the substrate may also be the substrate for a flat display device like an OLED (organic light emitting diode) device or a semiconductor wafer.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A substrate treating apparatus comprising:
a treatment solution dispenser supplying a treatment solution on a substrate;
a transporting unit transporting the substrate; and
a controller controlling the transporting unit so that the substrate is transported in an inclined position that is achieved through a rotation with respect to an axis extending parallel to a transportation direction of the substrate, wherein the rotation is made in both directions in an alternating manner.

2. A substrate treating apparatus comprising:
a transporting unit transporting a substrate in an inclined position; and
a treatment solution dispenser placed above the transporting unit and spraying a treatment solution more intensely on a lower part of the inclined substrate than on an upper part of the inclined substrate.

3. The substrate treating apparatus of claim 2, wherein the treatment solution dispenser comprises a lower part nozzle and an upper part nozzle, and wherein the lower part nozzle spraying the treatment solution on the lower part of the inclined substrate is disposed more closely to the substrate than the upper part nozzle spraying the treatment solution on the upper part of the inclined substrate.

4. The substrate treating apparatus of claim 2, wherein the treatment solution dispenser comprises:
a treatment solution pipe extending in a direction that is perpendicular to a transportation direction of the substrate; and
a plurality of nozzles connected with the treatment solution pipe.

5. The substrate treating apparatus of claim 4, wherein the treatment solution pipe is positioned at an adjustable inclination angle.

6. The substrate treating apparatus of claim 4, wherein the treatment solution pipe is disposed parallel to the substrate, and one of the nozzles spraying the treatment solution on the lower part of the inclined substrate is longer than one of the nozzles spraying the treatment solution on the upper part of the inclined substrate.

7. The substrate treating apparatus of claim 4, wherein the treatment solution pipe extends parallel to the substrate, and the nozzles become longer as they approach the lower part of the inclined substrate.

8. The substrate treating apparatus of claim 4, wherein the treatment solution pipe is closer to the lower part of the inclined substrate than to the upper part of the inclined substrate.

9. The substrate treating apparatus of claim 2, wherein the treatment solution dispenser comprises a nozzle having a first nozzle spraying the treatment solution on the upper part of the inclined substrate and a second nozzle spraying the treatment solution on the lower part of the inclined substrate, and a treatment solution pipe having a first treatment solution pipe connected with the first nozzle and a second treatment solution pipe connected with the second nozzle.

10. The substrate treating apparatus of claim 2, wherein the treatment solution dispenser comprises a plurality of treatment solution pipes disposed parallel to a transportation direction of the substrate and a plurality of nozzles connected with the treatment solution pipe.

11. The substrate treating apparatus of claim 10, wherein a distance between the upper part of the inclined substrate and the treatment solution pipe is longer than a distance between the lower part of the inclined substrate and the treatment solution pipe.

12. The substrate treating apparatus of claim 10, wherein a nozzle spraying the treatment solution on the lower part of the inclined substrate is closer to the substrate than a nozzle spraying the treatment solution on the upper part of the inclined substrate.

13. A substrate treating method comprising:
preparing a substrate and a treatment solution; and
transporting the substrate in an inclined position, wherein the inclined position is achieved by rotating the substrate with respect to an axis extending parallel to a transportation direction of the substrate, wherein the substrate is rotated in both directions in an alternating manner while receiving the treatment solution.

14. The substrate treating method of claim 13, wherein the transporting comprises transporting the substrate forward and backward.

15. The substrate treating method of claim 13, wherein the inclined position has an inclination angle of about 3° to about 7°.

16. The substrate treating method of claim 13, wherein the treatment solution is one of a developing solution, an etching solution, and a washing solution.

17. A substrate treating method comprising:
supplying a treatment solution to a substrate in a first treating unit while transporting the substrate that is inclined at a first inclination angle through a rotation with respect to an axis extending parallel to the transportation direction of the substrate;
supplying the treatment solution on the substrate in a second treating unit while transporting the substrate that is inclined at a second inclination angle smaller than the first inclination angle; and
supplying the treatment solution to the substrate in a third treating unit while transporting the substrate that is inclined at a third inclination angle that is a reverse of the first inclination angle.

18. The substrate treating method of claim 17, wherein the substrate is transported horizontally in the second treating unit such that the second inclination angle is zero.

19. The substrate treating method of claim 17, wherein the first inclination angle is equal in magnitude to the third inclination angle.

20. A substrate treating method comprising:
transporting a substrate that is inclined sideways through a rotation with respect to an axis extending parallel to a transportation direction of the substrate; and
supplying a treatment solution such that a spraying pressure of the treatment solution applied on a lower part of the inclined substrate is higher than that applied on an upper part of the inclined substrate.
